(19) United States
(12) Patent Application Publication
(10) Pub. No.: US 2003/0008765 A1
(43) Pub. Date: Jan. 9, 2003

(54) High-purity alumina sintered body, high-purity alumina ball, jig for semiconductor, insulator, ball bearing, check valve, and method for manufacturing high-purity alumina sintered body

(75) Inventors: Tomonori Niwa, Aichi (JP); Tetsuji Yogo, Aichi (JP)

Correspondence Address: SUGHRUE MION, PLLC, 2100 Pennsylvania Avenue, NW, Washington, DC, 20037-3213, US

(73) Assignee: NGK SPARK PLUG CO., LTD.

(21) Appl. No.: 10/238,602

(22) Filed: Sep. 11, 2002

Related U.S. Application Data
(62) Division of application No. 09/885,961, filed on Jun. 22, 2001, now abandoned.

(30) Foreign Application Priority Data
Jun. 23, 2000 (JP) 2000-188967

(51) Int. Cl. C04B 35/10

(52) U.S. Cl. 501/153

(57) ABSTRACT

A high-purity alumina sintered body having an alumina purity of not less than 99.9% by mass and a relative density of not less than 97% and exhibiting a weight loss of not greater than 100×10⁻⁴ kg/m² when immersed in boiling 6N H₂SO₄ or 6N NaOH aqueous solution for 24 hours as measured according to JIS R1614 (1993). The high-purity alumina sintered body is obtained by firing a green body formed from an alumina powder having an alumina purity of not less than 99.9% by mass and containing, as impurities, Si, an Mg, Fe and alkali metals including Na, K and Li in a total amount of less than 100 ppm.

### BACKGROUND OF THE INVENTION

1. Field of the Invention

The present invention relates to a high-purity alumina sintered body, to a high-purity alumina ball, to a method for manufacturing the alumina sintered body and alumina ball, and to a high-purity alumina component for applications requiring corrosion resistance.

2. Description of the Related Art

Alumina exhibits excellent wear resistance as compared with a metallic ball, and is thus favorably used for various industrial components. For example, a semiconductor treatment apparatus, such as an apparatus for fabricating ICs or LSIs, employs a ceramic jig for supporting a wafer. In this case, since a wafer is treated at high temperature within the apparatus, a jig made of an alumina ceramic sintered body is used in view of excellent resistance to corrosion at high temperature. Also, for example, a ball bearing used in a rotational drive unit of a semiconductor fabrication apparatus employs alumina ceramic balls as rolling elements in order to satisfy the requirement of corrosion resistance.

In the field of a check valve disposed in a fluid path so as to limit fluid flow to a single direction, a ceramic ball is used as a valve in equipment applications for filling bottles and cans with drink and apparatus operating at high speed and high frequency, such as a weft-insertion plunger pump for use in a water-jet loom. Such a ceramic ball for a check valve is exposed to fluids of various properties and is thus required to exhibit excellent corrosion resistance.

In order to exhibit sufficient insulation performance even under severe conditions, such as weathering conditions or fouling conditions of passing regions; for example, exposure to rainwater or polluted air over long term, an insulator must be made of alumina porcelain, which exhibits high corrosion resistance.

3. Problems Solved by the Invention

A conventional alumina ceramic is generally manufactured by the steps of adding, to an alumina material powder, a sintering aid in an amount of 1 to several % by mass, and sintering the resultant mixture. A sintering aid is a kind of flux and functions to generate a liquid phase during sintering to thereby densify a sintered body through rearrangement of alumina grains. Conventionally, in order to obtain a dense alumina sintered body, a sintering aid is generally added in an amount of at least 1-2% by mass. However, since SiO₂, MgO, and an alkali metal oxide, which are used as sintering aids, are localized at the grain boundary phase after sintering, impairment in corrosion resistance caused by intergranular corrosion is unavoidably involved.

On the other hand, a so-called high-purity alumina sintered body is commercially available. The high-purity alumina sintered body is fabricated by sintering which is performed using an electric furnace or a rotary kiln at approximately 2000° C., which is near the melting point of alumina, in order to reduce the amount of a sintering aid, thereby increasing the alumina content to approximately 99-99.5%. However, this commercially available high-purity alumina sintered body has the following drawbacks.

\mathring{1} In applications requiring particularly strict corrosion resistance, such as components for use in semiconductor manufacturing, the exhibited corrosion resistance level is not sufficient. Particularly, resistance to corrosion by strong acid or alkali used in etching, vapor deposition, or dopant diffusion tends to be insufficient.

\mathring{2} The melting process carried out within the electric furnace or the sintering process carried out within the rotary kiln involves sintering at high temperature near the melting point of alumina. Thus, material tends to deform, indicating a limitation on the degree of freedom of shape. Also, the allowance for machining increases, with a resultant increase in cost. Furthermore, high-temperature sintering tends to involve grain growth. As a result, strength and toughness tend to be insufficient in spite of high purity.

\mathring{3} In order to enhance dimensional accuracy, a manufacturing method can be employed in which sintering is performed after a pressing process. In this case, in order to suppress deformation, sintering must be performed at a relatively low temperature. In order to enhance the density of a sintered body obtained by low-temperature sintering, the density of a green body must be increased as much as possible. However, since the pressing process limits densification of a green body, the sintered body exhibits high porosity. Also, because of poor working efficiency, the pressing process unavoidably results in high manufacturing cost when applied to mass production of spherical sintered bodies of high accuracy, such as bearing balls. Furthermore, because of a tendency toward nonuniformity in density of green bodies, yield tends to decrease.

### SUMMARY OF THE INVENTION

It is therefore an object of the present invention to provide a high-purity alumina sintered body having excellent corrosion resistance, a high-purity alumina ball having excellent corrosion resistance, a method for manufacturing the alumina sintered body and the alumina ball, and a high-purity alumina component manufactured from the alumina sintered body for applications requiring corrosion resistance, such as ball bearings, jigs for semiconductors, check valves, and insulators.

The above object of the present invention has been achieved by providing, in a first embodiment, a high-purity alumina sintered body having an alumina purity of not less than 99.9% by mass and a relative density of not less than 97% and exhibiting a weight loss of not greater than 100×10⁻⁴ kg/m² when immersed in boiling 6N H₂SO₄ or 6N NaOH aqueous solution for 24 hours as measured according to JIS R1614 (1993).

In view of the problem of a conventional high-purity alumina sintered body, namely, insufficient corrosion resistance, the present inventors carried out extensive studies and found that, by enhancing the alumina purity (alumina content level) of an alumina sintered body to not less than 99.9% by mass, which is almost one order of magnitude higher than the conventional level, corrosion resistance, particularly that against acid and alkali, of the sintered body can be greatly improved, thereby achieving the present invention.

Specifically, the corrosion resistance level can be improved to a weight loss of not greater than 100×10^{-4 kg/m}² as measured according to the above-mentioned JIS specification. In the present invention, increasing the relative density of a sintered body to not less than 97% is essential in order to secure strength and toughness needed when the alumina sintered body is applied to various sintered components.

According to JIS R1614 (1993), incorporated herein by reference in its entirety, a test piece of predetermined shape and dimensions (3.0±0.1 mm thick, 4.0±0.1 mm wide, and at least 36 mm total length) is used to measure a loss in weight caused by corrosion by immersing in boiling 6N H₂SO₄ (3 mol/liter) aqueous solution or in a boiling 6N NaOH aqueous solution (6 mol/liter) for 24 hours. Herein, when, due to dimensional restrictions, the JIS test piece cannot be obtained from a sintered body, the test is conducted according to the JIS specification except that the sintered body itself is immersed in a corrosive test liquid. A loss in weight caused by corrosion is calculated by dividing a loss in weight of the sintered body by the surface area of the sintered body before testing.

In a second embodiment, the present invention provides a high-purity alumina sintered body having an alumina purity of not less than 99.9% by mass and a relative density of not less than 97% and containing, as impurities, an Si component, an Mg component, an Fe component, and alkali metal components including an Na component, a K component, and an Li component in a total amount of less than 100 ppm. As used herein, the content of each component refers to the elemental content and not to a compound or salt containing that element. A further study conducted by the present inventors revealed that the behavior of corrosion by acid or alkali keenly varies according to the content of impurities, particularly the total content of an Si component, an Mg component, an Fe component, and alkali metal components including an Na component, a K component and an Li component. Also, the present inventors found that a sintered body exhibits particularly good corrosion resistance when the total content of the impurities is at a certain level; specifically, less than 100 ppm. Notably, the second embodiment can be combined with the first embodiment.

In the aforementioned first and second embodiments, the alumina purity is preferably not less than 99.95% by mass.

Since the high-purity alumina sintered body of the present invention is far higher in alumina purity than existing high-purity alumina sintered bodies, an alumina powder used as a starting material must be of high purity; specifically, an alumina purity of not less than 99.9% by mass. Preferably, the alumina purity is not less than 99.95% by mass.

More preferably, an Si component, an Mg component, an Fe component, and alkali metal components including an Na component, a K component, and an Li component are present as impurities in a total amount of less than 50 ppm. Particularly preferably, alkali metal components; i.e., an Na component, a K component and an Li component, are present in a total amount of less than 30 ppm in view of enhanced corrosion resistance and insulation capability of an alumina sintered body thus obtained.

Having high density; specifically, having a relative density of not less than 97%, is essential for the high-purity alumina sintered body of the present invention. Excessive use of a sintering aid for enhanced densification of a sintered body is not acceptable, since purity is directly reduced. Also, in order to suppress deformation and unusual grain growth of a sintered body, sintering at high temperature near the melting point of alumina is undesirable. Accordingly, densification must be achieved by sintering at a relatively low temperature.

The present inventors carried out extensive studies and found that reducing the degree of nonuniformity in density of a green body by increasing the density to the highest possible extent is important, and that enhancement of the relative density of a green body to not less than 61% is effective for obtaining a green body of small nonuniformity in density. By enhancing the relative density of a green body to not less than 61%, the present inventors succeeded in enhancing the relative density of a sintered body containing almost no sintering aid to not less than 97% even when sintering is performed at a relatively low temperature (for example, 1400-1700° C., preferably 1500-1600° C.).

The BET specific surface area of the alumina powder is preferably 7-12 m²/g. The specific surface area is measured by the adsorption method. Specifically, the specific surface area is obtained from the amount of gas adsorbed on the surface of powder particles. According to general practice, an adsorption curve indicative of the relationship between the pressure of gas to be measured and the amount of adsorption is measured. The known BET (an acronym representing the originators, Brunauer, Emett, and Teller) formula related to polymolecular adsorption is applied to the adsorption curve so as to obtain the amount of adsorption vm upon completion of a monomolecular layer. A BET specific surface area calculated from the amount of adsorption vm is used as the specific surface area of the powder. However, when approximation does not make much difference, the amount of adsorption vm of the monomolecular layer may be read directly from the adsorption curve. For example, when the adsorption curve contains a section in which the pressure of gas is substantially proportional to the amount of adsorption, the amount of adsorption corresponding to the low-pressure end point of the section may be read as the vm value (refer to the monograph by Brunauer and Emett appearing in The Journal of American Chemical Society, Vol. 57 (1935), page 1754). Since molecules of adsorbed gas penetrate into a secondary particle to thereby cover individual constituent primary particles of the secondary particle, the specific surface area obtained by the adsorption method reflects the specific surface area of a primary particle and thus reflects the average value of the diameter of a primary particle d as shown in FIG. 11.

Preferably, in order to sufficiently densify alumina particles so as to obtain high density, the above-mentioned alumina powder is prepared in such a manner so as to have a relatively small BET specific surface area of 7-11 m²/g, which reflects the diameter of primary particles. When the BET specific surface area of the alumina powder is less than 7 m²/g, the diameter of primary particles becomes excessively large, potentially hindering attainment of a high density sintered body. When the BET specific surface area is in excess of 11 m²/g, unusual grain growth becomes likely to occur, potentially impairing the strength of a sintered body. Use of very fine alumina powder having an excessively large BET specific surface area results in an increased cost of manufacture thereof. Preferably, the BET specific surface area of the alumina powder is 9-11 m²/g.

For example, by enhancing the relative density of a sintered body to not less than 61% by using the above-mentioned alumina powder as a starting material and sintering at a temperature of 1400-1700° C., the sintered body can assume an average grain size of 2-5 μm. When the average grain size is in excess of 5 μm, the strength of the sintered body becomes insufficient. In order to densify a sintered body, the firing temperature must be 1400° C. or higher. However, employing such a firing temperature unavoidably involves grain growth; therefore, attainment of an average grain size of less than 2 μm is practically impossible. In view of further enhancement of the strength of a sintered body which is densified to a relative density of not less than 97%, the number of defects (pores) each having a size of not less than 1 μm is preferably less than 1000 per field of area measuring 50×50 μm as observed on the sectional microstructure of a sintered body, and the cumulative area percentage of defects is preferably not greater than 20%, more preferably not greater than 10%. Notably, the size (diameter) of a crystal grain or a defect is defined in the following manner. As shown in FIG. 15, various parallel lines circumscribe a crystal grain or a defect which is observed on the microstructure of a polished surface by means of SEM or like equipment. The size of the crystal grain or defect is represented by an average value of the minimum distance dmin between such parallel lines and the maximum distance dmax between such parallel lines (i.e., size d=(dmin+dmax)/2).

In view of formability, use of an alumina powder having the following properties as a starting material is preferred. Specifically, the 90% grain size is 1-3 μm, the 50% grain size is 0.5-0.9 μm, and the 10% grain size is 0.2-0.4 μm, as measured with a laser diffraction granulometer. Herein, the cumulative relative frequency with respect to grain size as measured in the ascending order of grain size is defined in the following manner. As shown in FIG. 12(a), frequencies of grain sizes of particles to be evaluated are distributed in the ascending order of grain size. In the cumulative frequency distribution of FIG. 12(a), N_{c} represents the cumulative frequency of grain sizes up to the grain size in question, and N₀ represents the total frequency of grain sizes of particles to be evaluated. The relative frequency nrc is defined as “(N_{c}/N₀)×100 (%).” The X% grain size refers to a grain size corresponding to nrc=X (%) in the distribution of FIG. 12(b). For example, the 90% grain size is a grain size corresponding to nrc=90 (%), and the 50% grain size is a grain size corresponding to nrc=50%.

By using an alumina powder having a purity and an average grain size, a 90% grain size, a 50% grain size, and 10% grain size as measured using a laser diffraction granulometer, falling within the above-mentioned respective ranges and a BET specific surface area falling within the above-mentioned range, a green body formed therefrom is unlikely to suffer nonuniform density or discontinuous boundaries which would otherwise result from localized distribution of powder particles. This results in a sintered body of high density and high purity. The measuring principle of a laser diffraction granulometer is well known in the art. Briefly, sample powder is irradiated with a laser beam. A beam diffracted by powder particles is detected by means of a photodetector. The scattering angle and the intensity of the diffracted beam are obtained from the data detected by the photodetector. The grain size of the sample powder can be obtained from the scattering angle and the intensity.

A high-purity alumina powder often contains secondary particles, as shown schematically in FIG. 11. Various factors, such as the action of an added organic binder and an electrostatic force, cause a plurality of primary particles to aggregate into a secondary particle. In measurement by use of a laser diffraction granulometer, an aggregate particle and a solitary primary particle do not exhibit much difference in the diffracting behavior of an incident laser beam. Accordingly, whether a measured grain size is of a solitary primary particle or of an aggregate secondary particle is not definitely known. That is, the thus-measured grain size reflects the diameter of a secondary particle D shown in FIG. 11 (in this case, a solitary primary particle is also considered to be a secondary particle as defined in a broad sense). The 90%, 50%, and 10% grain sizes calculated from the measured grain sizes reflect 90%, 50%, and 10% grain sizes of secondary particles.

Preferably, the 90%, 50%, and 10% grain sizes, which reflect diameters of secondary particles, are respectively set to small values; specifically, 1-3 μm, 0.5-0.9 μm, and 0.2-0.4 μm. Such setting eliminates aggregation of particles as secondary particles, to thereby eliminate localized variation in charge density of particles. Therefore, by employing such grain size ranges, the density of alumina particles can be readily increased.

Notably, when the 90%, 50%, and 10% grain sizes of an alumina powder are in excess of 5 μm, 2 μm, and 0.6 μm, respectively, a green body becomes likely to suffer localized distribution of powder particles and thus potentially suffers low alumina-particle density. Meanwhile, a particularly fine alumina powder having a 90% grain size of less than 1 μm, a 50% grain size of less than 0.5 μm, and a 10% grain size of less than 0.2 μm requires a considerably long preparation time (for example, a considerably long pulverization time), resulting in increased manufacturing cost attributable to impaired manufacturing capability.

When a high-density green body having a relative density of not less than 61% is to be manufactured by a pressing process, densification and homogenization of a formed green body through, for example, cold isostatic pressing (CIP) are important. This enables firing of high-purity alumina powder, which has been conventionally impossible, in order to obtain a spherical sintered body. As a result, a high-purity alumina sintered body or a high-purity alumina ball can be obtained. By employing the following rolling granulation process, spherical green bodies of high density can be manufactured at high efficiency. In contrast to the pressing process involving formation of an unnecessary flange-like portion on a green body, the rolling granulation process does not involve formation of such a portion on a green body, thereby avoiding increase in allowance for polishing.

The method of the present invention for manufacturing a high-purity alumina sintered body comprises:

a rolling granulation process for obtaining a spherical green body having a relative density of not less than 61%, the rolling granulation process comprising the steps of: preparing a forming material powder from high-purity alumina powder; placing the forming material powder in a granulation container; and rolling an aggregate of the alumina powder within the granulation container such that the aggregate grows into a spherical body; and

a firing process for firing the spherical green body to obtain a high-purity alumina ball serving as the high-purity alumina sintered body.

A preferred mode for carrying out the rolling granulation process will next be described.

A spherical green body of high density can be obtained by employing a method in which an alumina powder is caused to adhere to a green body in the process of rolling granulation while liquid predominantly comprising a liquid forming-medium is supplied. The liquid forming-medium can be, but is not limited to, an aqueous solvent; specifically, water or an aqueous solution prepared by addition of an appropriate additive to water. For example, the liquid forming-medium may be an organic solvent. It is considered that the method yields the following effect: when the liquid forming-medium and the alumina powder adhere to pits and projections present on the surface of a green body, the osmotic pressure of the liquid forming-medium causes powder particles to adhere to the green body while being densely arrayed, to thereby enhance the density of the green body. In order to enhance the effect, preferably, the liquid forming-medium is sprayed directly over the green body. Spraying the liquid forming-medium may extend over the entire forming process (for example, the entire rolling granulation process) or over a portion (for example, the end stage) of the forming process. Also, the liquid forming medium may be supplied continuously or intermittently.

Preferably, rolling granulation is performed by the steps of placing the alumina powder and forming nuclei in a granulation container; and rolling the forming nuclei within the granulation container so as to cause the alumina powder to adhere to and aggregate on the forming nuclei spherically, thereby yielding spherical green bodies. The forming nuclei roll on, for example, an alumina powder layer within the granulation container such that the alumina powder adheres to and aggregates on the forming nuclei spherically, to thereby yield spherical green bodies. This forming process greatly enhances the density of an aggregate layer of the alumina powder growing on a forming nucleus, and yields the effect that the formed aggregate layer becomes unlikely to suffer defects, such as pores or cracks, which would otherwise result from, for example, bridging of powder particles. Notably, rotating the granulation container is a simple method for rolling forming nuclei (or growing green bodies). However, for example, by utilizing a principle similar to that of a vibration-type barrel polishing apparatus, vibration may be applied to the granulation container so as to excite rolling of the forming nuclei by vibration.

In this case, an alumina ball obtained by firing has a core portion formed at a central portion in a distinguishable manner from an outer layer portion as observed on a cross section taken substantially across the center of the ball. Herein, the term “distinguishable” encompasses not only a visually distinguishable case but also a case where the core portion is distinguishable from the outer layer portion by measuring a difference in certain physical properties (for example, density and hardness).

A green body may be fired by means of the atmospheric sintering process, the hot pressing process, the hot isostatic pressing (HIP) process, or a like process. Alternatively, these processes may be combined in various ways. For example, a green body may undergo atmospheric sintering for preliminary firing, followed by hot isostatic pressing. The firing temperature is 1400-1700° C., preferably 1500-1600° C. As a result of firing at the above temperature a green body to which an enhanced relative density of not lower than 61% is imparted by means of the above-described rolling granulation process, a ball obtained through firing can exhibit a maximum pore size of not greater than 10 μm in the surface layer region, even though the green body is spherical. The HIP process enables firing in an inert gas atmosphere having a pressure of 100-2000 atmospheres. The HIP process can reduce the maximum pore size to not greater than approximately 5 μm, further to not greater than approximately 3 μm.

The high-purity alumina sintered body of the present invention, which is obtained by sintering a green body made of the high-purity alumina powder, is favorably applicable to a high-purity alumina component for use under corrosive conditions; specifically, jigs for semiconductors, balls for use in ball bearings, balls for use in check valves, or insulators.

For example, a plurality of high-purity alumina balls of the present invention are incorporated as rolling elements between an inner ring (inner race) and an outer ring (outer race) to thereby form a ball bearing. Such a ball bearing can be favorably used as, for example, a bearing component of a drive unit of a semiconductor fabrication apparatus. The inner and outer rings can be made of steel having an Ni content of not greater than 3% by mass (including 0% by mass), such as high-carbon chromium bearing steel (for example, SUJ1, SUJ2, or SUJ3 prescribed in JIS G4805 (1990)).

Also, a check valve can be formed by use of the high-purity alumina ball of the present invention. Specifically, a check valve comprises a valve body having a fluid path formed therein and a ball disposed within the fluid path so as to limit fluid flow within the fluid path to a single direction, the ball being the above-described high-purity alumina ball of the present invention. The high-purity alumina ball exhibits enhanced corrosion resistance, whereby the check valve provides long life.

Furthermore, a jig for a semiconductor can be formed by use of the high-purity alumina sintered body of the present invention. A specific example of the jig is a high-purity alumina sintered component assuming a flat cylindrical shape. The high-purity alumina sintered component has a wafer-receiving recess for receiving a wafer formed on one end surface thereof and a positioning recess formed on the other end surface thereof, the end surfaces being polished so as to be substantially parallel with each other. The high-purity alumina sintered component is used as a jig for supporting a wafer within a processing apparatus; for example, when ICs or LSIs are to be formed on the wafer through a diffusion process. In this case, during the diffusion process, a corrosive atmosphere of high temperature is established within the process apparatus in which the jig and the wafer are disposed. Thus, the jig must have such strength and corrosion resistance as to endure use in the atmosphere. The high-purity alumina sintered component can sufficiently meet such requirements.

The high-purity alumina sintered body of the present invention can be applied to various insulators; for example, a clevis-type suspension insulator, a long rod insulator, and a line post insulator. Through application of the high-purity alumina sintered body, the insulators exhibit enhanced corrosion resistance even under severe conditions, such as weathering conditions or fouling conditions of passing regions, to thereby provide long life.

### BRIEF DESCRIPTION OF THE DRAWINGS

FIG. 1 is a view showing a step of rolling granulation.

FIG. 2 is a view showing a step of rolling granulation subsequent to the step of FIG. 1.

FIGS. 3(a)-3(e) are views showing several examples of a green body.

FIGS. 4(a)-4(e) are views showing several examples of a method for manufacturing a green body.

FIGS. 5(a)-5(c) are views showing a rolling granulation process, depicting the progress of rolling granulation.

FIG. 6 is a schematic view showing the cross-sectional structure of a spherical ceramic sintered body manufactured by rolling granulation.

FIG. 7 is a view showing the rolling granulation process.

FIG. 8 is a half sectional view showing an insulator formed from a high-purity alumina sintered body of the present invention.

FIGS. 9(a) and 9(b) are front views showing other insulators formed from a high-purity alumina sintered body of the present invention.

FIGS. 10(a)-10(c) are schematic views showing jigs for holding a wafer, which jigs are formed from a high-purity alumina sintered body of the present invention.

FIG. 11 illustrates the concept of the diameter of a primary particle and the diameter of a secondary particle.

FIGS. 12(a) and 12(b) illustrate the concept of cumulative relative frequency.

FIG. 13 is a schematic view showing a ball bearing using high-purity alumina balls of the present invention.

FIG. 14 is a longitudinal sectional view and front view showing an example of a check valve.

FIG. 15 illustrates the definition of the size d of a pore.

### DESCRIPTION OF REFERENCE NUMERALS

40: ball bearings

43, 243: high-purity alumina balls

200: check valve

350: jig for holding wafer

400, 500: insulators

### DETAILED DESCRIPTION OF THE PREFERRED EMBODIMENTS

Embodiments of the present invention will be described, first, with reference to ceramic balls for use in a bearing. However, the present invention should not be construed as being limited thereto. Starting materials for the ball are as follows: (A) a high-purity alumina powder having an alumina purity of 99.99%, a 90% grain size of 1.96 μm, a 50% grain size of 0.68 μm, a 10% grain size of 0.32 μm, and a BET specific surface area of 11.0 and (B) a high-purity alumina powder having an alumina purity of 99.9%, a 90% grain size of 2.53 μm, a 50% grain size of 0.80 μm, a 10% grain size of 0.36 μm, and a BET specific surface area of 7.0. The alumina powders (A) and (B) each contain, as impurities, an Si component of less than 10 ppm, an Na component of less than 5 ppm, an Mg component of less than 1 ppm, and an Fe component of less than 8 ppm.

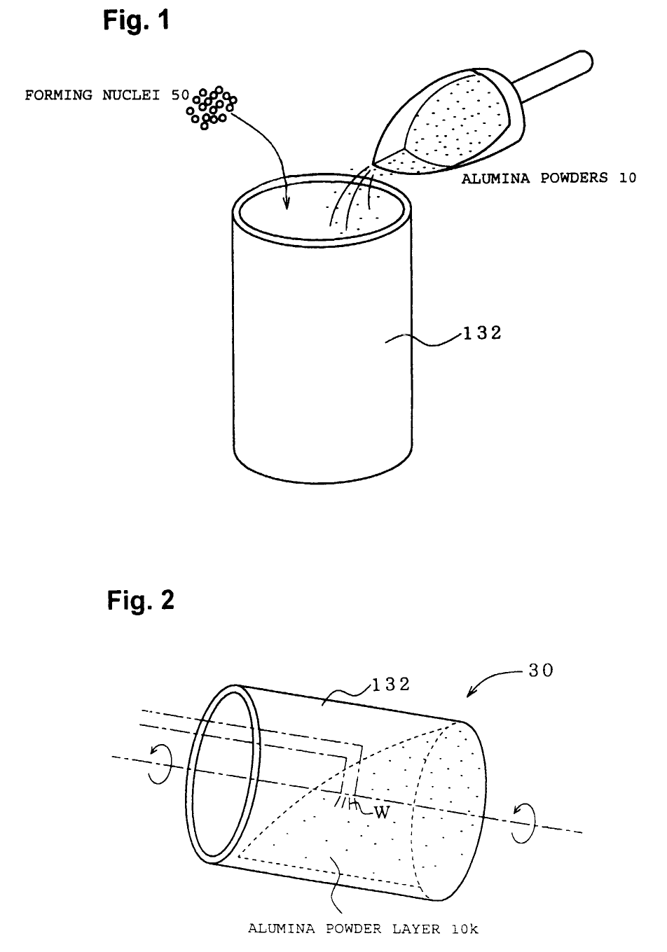

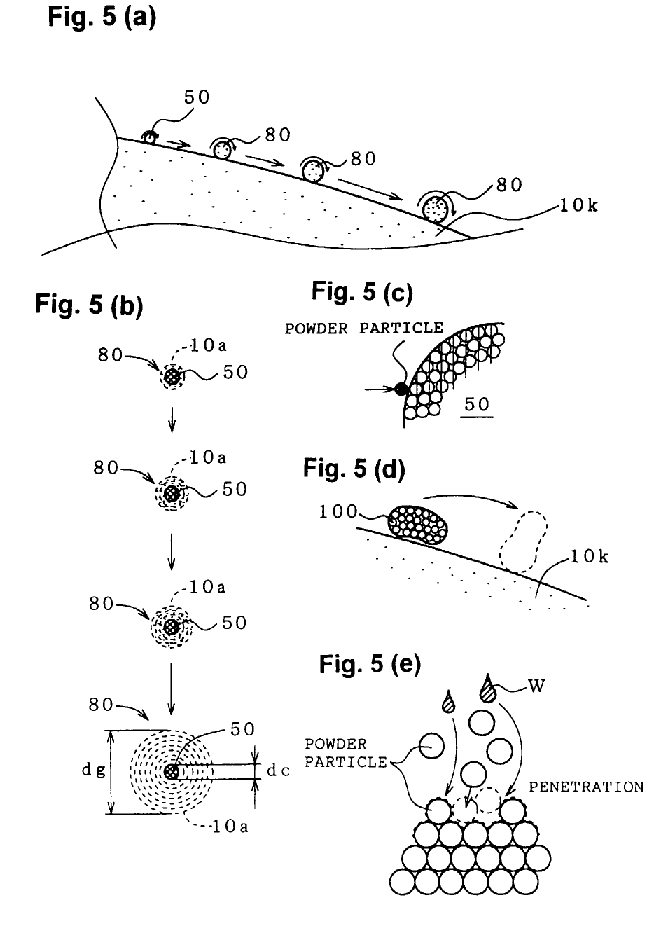

The alumina powders 10 can be each formed into spherical bodies by means of the rolling granulation process. Specifically, as shown in FIG. 1, the alumina powder 10 is placed in a granulation container 132. As shown in FIG. 2, the granulation container 132 is rotated at a constant peripheral speed. Water W is fed to the alumina powder 10 contained in the granulation container 132, for example, by spraying. As shown in FIG. 5(a), the charged alumina powder 10 rolls down an inclined powder layer 10k formed in the rotating granulation container 132 to thereby spherically aggregate into a green body 80. The operating conditions of a rolling granulation apparatus 30 are adjusted such that the resulting green body 80 assumes a relative density of not lower than 61%. Specifically, the rotational speed of the granulation container 132 is adjusted to 10-200 rpm. The water feed rate is adjusted such that the finally obtained green body 80 assumes a water content of 10-20% by weight. By using an alumina powder 10 which contains the aforementioned sintering aid powder in an amount of 1-10% by weight and by rolling granulation of the alumina powder 10 under the above conditions, the resulting green body 80 can assume a relative density of not lower than 61%.

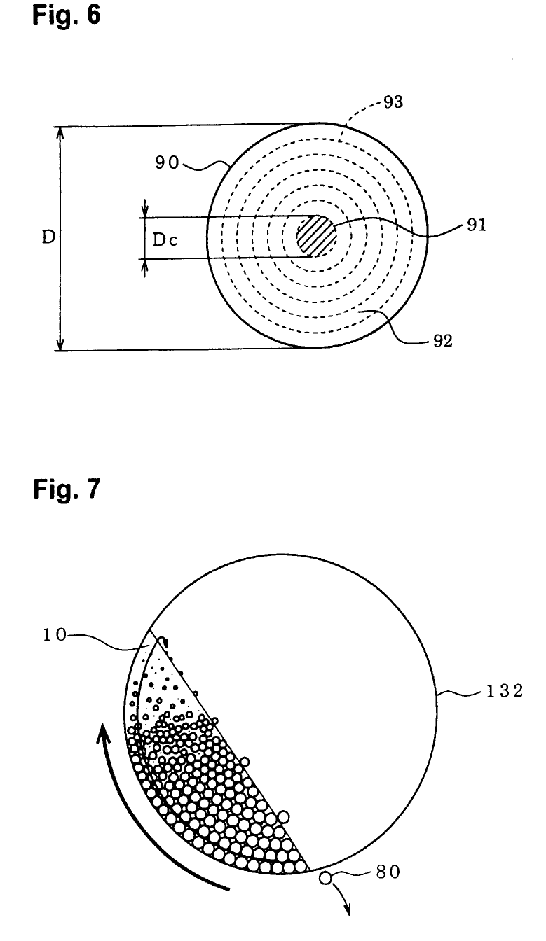

In order to accelerate the growth of the green body 80 during rolling granulation, as shown in FIG. 1, preferably, forming nuclei 50 are placed in the granulation container 132. While the forming nucleus 50 is rolling down the alumina powder layer 10k as shown in FIG. 5(a), the alumina powder 10 adheres to and aggregates on the forming nucleus 50 spherically, as shown in FIG. 5(b), to thereby form the spherical green body 80 (rolling granulation process). The green body 80 is sintered to thereby become an unfinished bearing ball 90 as shown in FIG. 6.

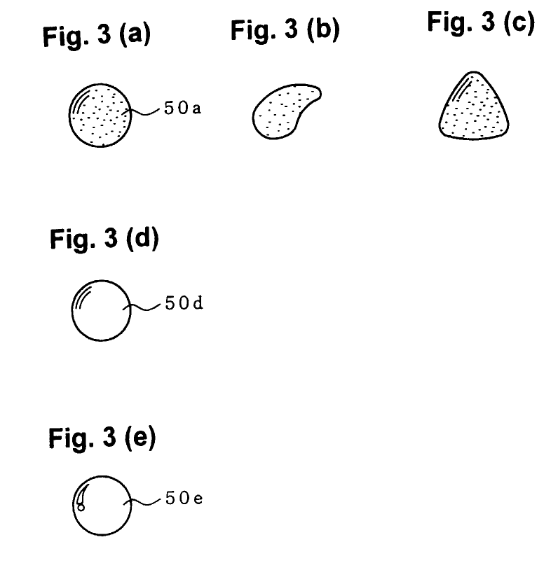

Preferably, the forming nucleus 50 is formed predominantly of alumina powder as represented by a forming nucleus 50a shown in FIG. 3(a). This is because the nucleus 50a is unlikely to act as an impurity source on the finally obtained alumina ball 90. However, when there is no possibility of a nucleus component diffusing to a surface layer portion of the alumina ball 90, the nucleus 50 may be formed of a ceramic powder different from the alumina powder; alternatively, the nucleus 50 may be a metal nucleus 50d shown in FIG. 3(d) or a glass nucleus 50e shown in FIG. 3(e). Also, the nucleus 50 may be formed of a material which disappears through thermal decomposition or evaporation during firing; for example, the nucleus 50 may be formed of a polymeric material, such as wax or resin. The forming nucleus 50 may assume a shape other than a sphere, as shown in FIG. 3(b) or 3(c). Preferably, the forming nucleus 50 assumes a spherical shape, as shown in FIG. 3(a), in order to enhance the sphericity of a green body thus obtained.

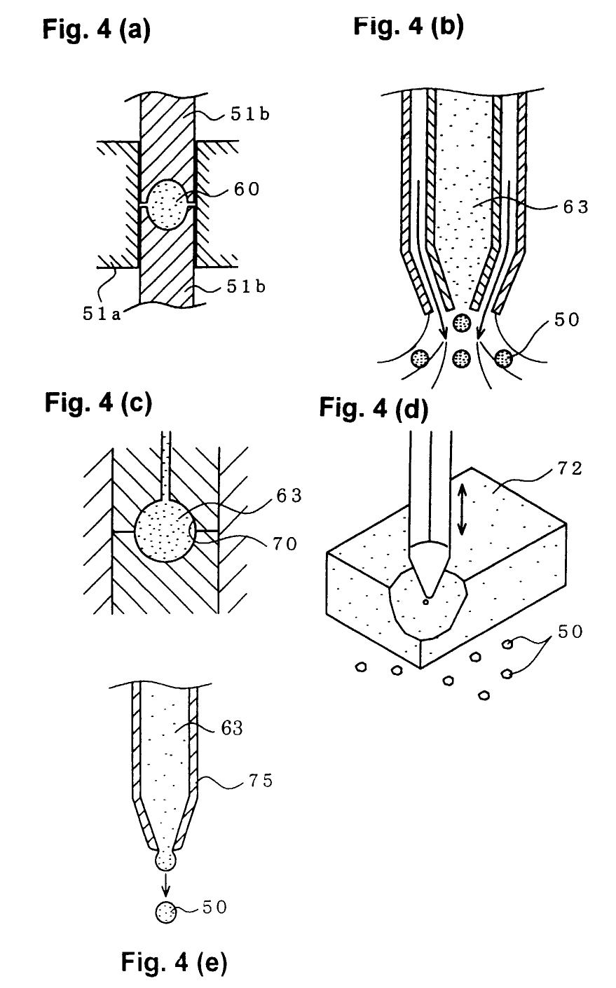

The method for manufacturing the forming nuclei 50 is not particularly limited. For example, various methods as shown in FIG. 4 can be employed. According to the method shown in FIG. 4(a), an alumina powder 60 is compacted by means of a die 51a and press punches 51b (other compression means may be used instead), thereby obtaining the nucleus 50. According to the method shown in FIG. 4(b), ceramic powder is dispersed into a molten thermoplastic binder to obtain a molten compound 63, and the thus-obtained molten compound 63 is sprayed and solidified, thereby obtaining the nuclei 50. According to the method shown in FIG. 4(c), the molten compound 63 is injected into a spherical cavity 70 formed in an injection mold, thereby molding the spherical nucleus 50. As illustrated in FIG. 4(d), nucleus 50 can be made by crushing a fired ceramic body 72. According to the method shown in FIG. 4(e), the molten compound 63 is caused to fall freely from a nozzle 75 so as to assume a spherical shape by means of surface tension effect, and the thus-formed spherical droplet is cooled and solidified in the air to become the nucleus 50. Alternatively, a slurry is formed from starting material powder, a monomer (or a prepolymer), and a dispersant solvent. The slurry is dispersed in a liquid which does not mix with the slurry, so as to assume the form of globules in the liquid. Then, the monomer or prepolymer is polymerized, thereby obtaining spherical bodies, which serve as the nucleus 50. Alternatively, the alumina powder 10 is singly placed in the granulation container 132, and the granulation container 132 is rotated at a speed lower than that for growing the green body 80 (see FIG. 2), so as to form powder aggregates. When powder aggregates of sufficiently large size are generated in a sufficient amount, the rotational speed of the aggregation container 132 is increased to thereby grow the green bodies 80 while utilizing the aggregates as the nuclei 50. In this case, there is no need to place the nuclei 50 manufactured in a separate process, in the granulation container 132 together with the alumina powder 10.

The thus-obtained forming nucleus 50 does not collapse and can stably maintain its shape even when some external force is imposed thereon. Thus, when the nucleus 50 rolls down the alumina powder layer 10k as shown in FIG. 5(a), the nucleus 50 can reliably sustain reaction induced from its own weight. Conceivably, since powder particles which are caught on the rolling nucleus 50 can be firmly pressed on the surface of the nucleus 50 as shown in FIG. 5(e), the powder particles are appropriately compressed to thereby grow into a highly dense aggregate layer 10a. Notably, rolling granulation can be performed without the use of nuclei. As shown in FIG. 5(d), since an aggregate 100 corresponding to a nucleus is rather loose and soft at the initial stage of formation, lowering the rotational speed of the granulation container 132 is preferable in order to prevent the occurrence of defects.

The size of the nucleus 50 is at least approximately 40 μm (preferably, approximately 80 μm). When the nucleus 50 is too small, the growth of the aggregate layer 10a may become incomplete. When the nucleus 50 is too large, the thickness of the aggregate layer 10a to be formed becomes insufficient; as a result, a sintered body tends to suffer the occurrence of defects. Preferably, the size of the nucleus 50 is, for example, not greater than 1 mm.

Preferably, the forming nucleus 50 assumes the form of an aggregate of alumina powder having a density higher than the bulk density (for example, apparent density prescribed in JIS Z2504 (1979)) of the alumina powder 10. Such an aggregate of alumina powder can reliably sustain the pressing force of powder particles to thereby accelerate the growth of the aggregate layer 10a. Specifically, an aggregate of alumina powder having a density at least 1.5 times the bulk density of the alumina powder 10 is preferred. In this case, sufficient aggregation is such that, when an aggregate rolls down the alumina powder layer 10k, the aggregate does not collapse from the shock of rolling.

In order to grow the green body 80 more stably, preferably, the size of the nucleus 50 is determined according to the size of the green body 80 in the following manner. As shown in FIG. 5(b), the size of the forming nucleus 50 is represented by the diameter dc of a sphere having a volume equal to that of the nucleus 50 (when the nucleus 50 is spherical, the diameter thereof is the size in question), and the diameter of the finally obtained spherical green body 80 is represented by dg. The diameter dc is determined such that dc/dg is 1/100-½. When dc/dg is less than 1/100, the nucleus 50 becomes too small, potentially causing insufficient growth of the aggregate layer 10a or occurrence of many defects in the aggregate layer 10a. When dc/dg is in excess of ½, and the density of the nucleus 50 is not sufficiently high, the strength of a sintered body thereby obtained may become insufficient. The ratio dc/dg is preferably 1/50-⅕, more preferably 1/20-1/10. The size dc of the forming nucleus 50 is preferably 20-200 times the average grain size of the alumina powder 10. Preferably, the absolute value of the size dc is, for example, 50-500 μm.

For example, the green body 80 is sintered by the method to be described later, to thereby obtain a high-purity unfinished alumina ball. Conventionally, HIP is often employed in firing for manufacture of alumina. However, the green body 80 manufactured by the rolling granulation process can be sintered to a highly dense sintered body even by means of the atmospheric sintering process, for the following reason. Since the relative density of the green body 80 is enhanced to not lower than 61%, and the alumina powder 10 uniformly adheres to and aggregates on the nucleus 50, the green body 80 hardly suffers locally formed large pores. In this case, atmospheric sintering can be performed in the atmosphere, a vacuum, or an inert gas atmosphere. The sintering temperature is 1400-1700° C., preferably 1500-1600° C. The HIP process can be employed. HIP is performed in an inert gas atmosphere having a pressure of 1000-2000 atmospheres at a temperature of 1400-1700° C., preferably 1500-1600° C. In this case, two-stage firing is effective for attaining high density and reducing the maximum pore size. Specifically, a presintered body having an enhanced relative density of not lower than 95% is manufactured by atmospheric sintering. Then, the presintered body undergoes HIP.

As a result of using the green body 80 whose relative density is enhanced to not less than 61% through manufacture by the aforementioned rolling granulation process, the unfinished alumina ball 90 obtained by sintering the green body 80 exhibits a relative density of not less than 97%. The average diameter of crystal grains as observed on the cross-sectional microstructure of the unfinished alumina ball 90 is approximately 2-5 μm, preferably approximately 2-3 μm. Furthermore, the size of the largest pore formed in the surface layer region extending radially from the surface of the ball 90 to a depth of 50 μm as observed on a polished cross section of the ball 90 taken substantially across the center of the ball 90 can be reduced to not greater than 10 μm when atmospheric sintering is employed, and can be reduced to not greater than 5 μm when HIP is employed. The unfinished ball 90 is subjected to rough polishing for dimensional adjustment and then is subjected to fine polishing, which is performed using stationary abrasive grains. The alumina ball of the present invention is thus obtained. The alumina ball can assume the feature that the cumulative area percentage of pores each having a size of not less than 1 μm as observed on the polished surface is not greater than 20%, preferably not greater than 10%, and that the average number of the pores present in a unit area of 2.5×10⁻³ mm² on the polished surface is not greater than 1000. Also, the alumina ball can assume an arithmetic average roughness Ra of not greater than 0.012 μm as observed on the polished surface, and a sphericity of not greater than 0.08 μm. In order to achieve such accuracy of the polished surface, employment of the HIP process is particularly effective. Furthermore, diametral irregularity among the alumina balls can be not greater than 0.10 μm.

The unfinished ball 90 obtained by firing the spherical green body 80 which, in turn, is obtained by means of the rolling granulation process has the structure shown in FIG. 6, which is an enlarged schematic view showing a polished cross section taken substantially across the center of the ball 90. Specifically, a core portion 91 derived from the forming nucleus 50 is formed at a central portion of the unfinished ball 90 distinguishably from an outer layer portion 92, which is derived from the aggregate layer 10a and features high density and few defects. In many cases, the core portion 91 exhibits a visually distinguishable contrast with the outer layer portion 92 with respect to at least brightness or color tone. Conceivably, such contrast is exhibited because of difference between alumina density ρe of the outer layer portion 92 and alumina density ρc of the core portion 91. For example, when the forming nucleus 50 (FIG. 5) is lower in density than the aggregate layer 10a, the alumina density ρe of the outer layer portion 92 becomes higher than the alumina density ρc of the core portion 91 in many cases. As a result, the color tone of the outer layer portion 92 becomes brighter than that of the core portion 91. In view of attainment of appropriate strength and durability of alumina, the relative density of the outer layer portion 92 is not lower than 99%, preferably not lower than 99.5%. In any case, by attaining a sintered-body structure such that the above-mentioned structural feature appears on a polished cross section, a spherical high-purity alumina sintered body can be realized featuring high density, high strength, and a low fraction of defects (for example, to such an extent that no pores are observed) at the surface layer portion 92, which is a key to enhancing the performance, for example, of a bearing. In the case where firing has proceeded uniformly, a resultant sintered body may exhibit substantially uniform density in a radial direction from a surface layer portion to a central portion. Alternatively, even when the core portion 91 and the outer layer portion 92 differ in color tone or lightness, almost no difference may exist in density therebetween. In the case where firing has proceeded in a highly uniform manner, concentric contrast patterns may not be visually observed at the core portion 91 or at the outer layer portion 92.

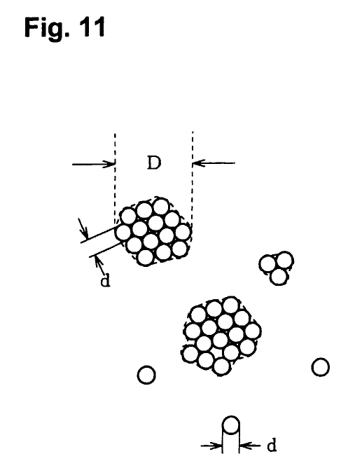

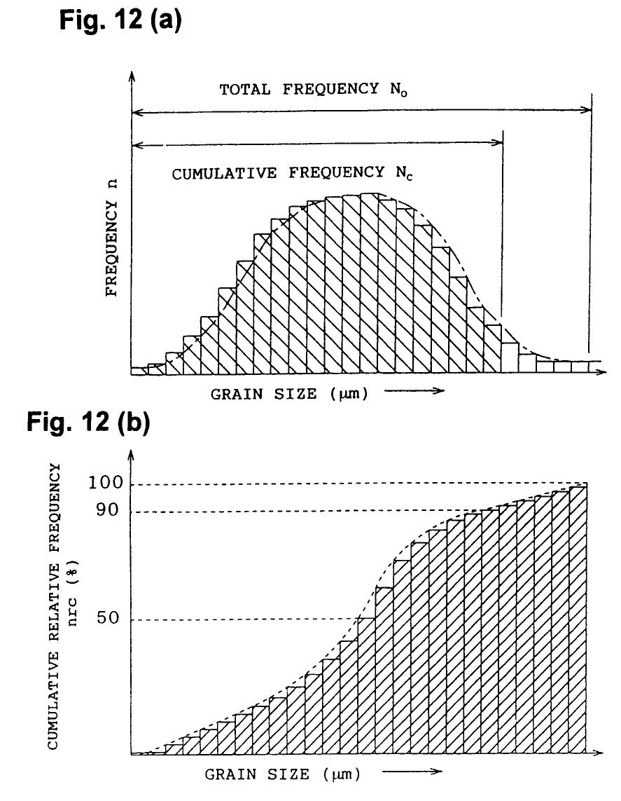

When dc/dg is adjusted to 1/100-½ (preferably 1/50-⅕, more preferably 1/20-⅕), where, as shown in FIG. 5(b), dc is the diameter of the forming nucleus, and dg is the diameter of an unfinished ball obtained by firing, the cross section of the sintered body 90 shown in FIG. 6 assumes a structure such that Dc/D is 1/100-½ (preferably 1/50-⅕, more preferably 1/20-1/10), where Dc is the diameter of a circle having an area equal to that of the core portion 91 (when the nucleus 50 is formed of a material which disappears by thermal decomposition or evaporation during firing; for example, wax, resin, or like polymeric material, the core portion 91 becomes a void portion), and D is the diameter of the alumina sintered body. When Dc/D is less than 1/50, the aggregate layer 10a (FIG. 11), which becomes the outer layer portion 92, tends to suffer defects, potentially resulting in insufficient strength. When Dc/D is in excess of ⅕, and, for example, the density of the nucleus 50 is not very high, the strength of the sintered body may become insufficient. Dc/D is preferably 1/20-1/10.

An example of visually distinguishable contrast between the core portion 91 and the outer layer portion 92 in the unfinished ball 90 is the state in which brightness or color tone differs in the radial direction of the ball 90 while being unchanged in the circumferential direction. Specifically, a concentric layer pattern is formed in the outer layer portion 92 so as to surround the core portion 91 as observed on the polished cross section of the unfinished ball 90. This is a typical structural feature (which is applied to a polished alumina ball accordingly) as observed in employing the rolling granulation process. It is considered that this structural feature arises for the following reason. As shown in FIG. 5(a), while the green body 80 is rolling down the alumina powder layer 10k, the aggregate layer 10a grows. However, during rolling granulation, the green body 80 is not always present on the alumina powder layer 10k. That is, as shown in FIG. 7, since the alumina powder 10 slides like an avalanche as the granulation container 132 rotates, the green body 80 which has reached the lower end portion of the slope of the alumina powder layer 10k is caught into the alumina powder layer 10k. Then, the green body 80 is brought up along the wall surface of the granulation container 132 to an upper end portion of the slope of the alumina powder layer 10k. The green body 80 again rolls down the alumina powder layer 10k. When the green body 80 is caught in the alumina powder layer 10k, the green body 80 is pressed by the surrounding alumina powder 10, and is thus less susceptible to impact associated with a rolling-down motion. As a result, powder particles adhere to the green body 80 in a relatively loose manner. By contrast, when the green body 80 rolls down the alumina powder layer 10k, the green body 80 is subjected to impact associated with a rolling-down motion and is susceptible to the spray of liquid spray medium W, such as water. As a result, powder particles adhere to the green body 80 in a relatively tight manner. Since the green body 80 rolls down and is caught in the alumina powder layer 10k cyclically, the state of powder adhesion varies cyclically. Accordingly, the aggregate layer 10a, which is formed of adhering powder particles, involves repetitions of condensation and rarefaction in the radial direction. Even after sintering, the repetitions of condensation and rarefaction emerge in the form of a delicate difference in density, thereby forming a layer pattern 93 (when the difference between condensation and rarefaction is very small, the actual occurrence of condensation and rarefaction may not be observed by means of ordinary density measurement, since the precision of the measurement is not sufficiently high). It is considered, for example, that the layer pattern 93 is composed of concentric spherical portions of different densities, which are alternately arranged in layers.

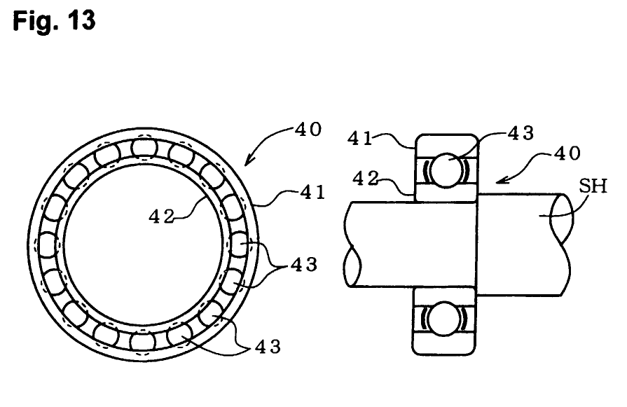

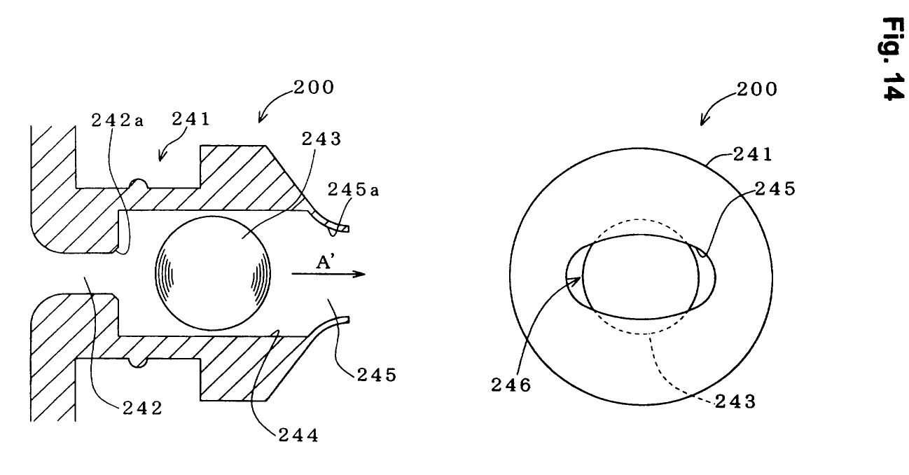

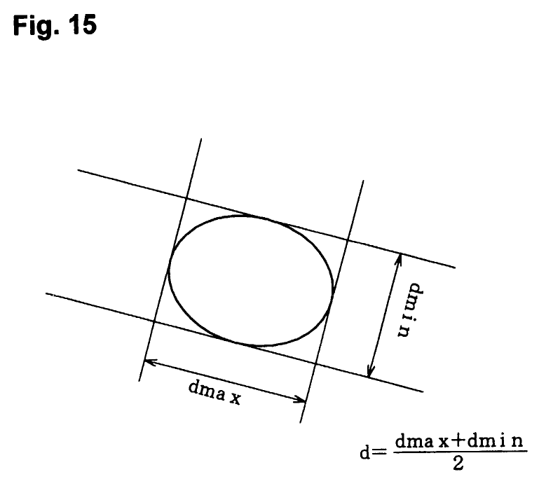

As shown in FIG. 13, high-purity alumina balls 43 obtained as above are incorporated between an inner ring 42 and an outer ring 41, which are made of, for example, metal or ceramic, thereby yielding a radial ball bearing 40. When a shaft SH is fixedly attached to the internal surface of the inner ring 42 of the ball bearing 40, the alumina balls 43 are supported rotatably or slidably with respect to the outer ring 41 or the inner ring 42. By attaining an alumina purity of not less than 99.9% by mass, the high-purity alumina ball 43 can have greatly enhanced durability, whereby the life of the ball bearing 40 can be extended.

FIG. 14 shows an example of application of the above-mentioned high-purity alumina ball to a check valve. The check valve 200 includes a valve body 241. The valve body 241 internally includes a fluid (for example, liquid) inlet portion 242, a passage chamber 244, and an outlet portion 245, which are arranged in an order forming a fluid path. A high-purity alumina ball 243 is disposed within the passage chamber 244. The passage chamber 244 has a cylindrical wall having a diameter greater than that of the high-purity alumina ball 243. The high-purity alumina ball 243 can axially reciprocate within the passage chamber 244. The inlet portion 242 communicates with the passage chamber 244 and assumes a cylindrical form having a diameter smaller than that of the passage chamber 244. The inlet portion 242 has a taper seat 242a formed at an open end edge which faces the opening of the passage chamber 244. The outlet portion 245 includes a stopper portion 245a (herein, a tapered diameter-reduced portion) adapted to prevent the high-purity alumina ball 243 from moving further in the direction of fluid flow. The outlet portion 245 is formed such that, when the high-purity alumina ball 243 is caught by the stopper portion 245a, a clearance 246 is formed in order to allow fluid to flow therethrough. The surface of the high-purity alumina ball 243 is not required to be finished to as high a finishing accuracy level as the high-purity alumina balls for bearings. A high-purity alumina ball obtained by firing is used as the high-purity alumina ball 243 without being polished or after being briefly polished for dimensional adjustment.

The check valve 200 functions in the following manner. When fluid flows from the inlet portion 242 toward the outlet portion 245 in direction A′, the high-purity alumina ball 243 moves toward the outlet portion 245. Since the high-purity alumina ball 243 is caught by the stopper portion 245a, fluid flows out through the clearance 245. By contrast, when fluid attempts to flow backwards from the outlet portion 245 toward the inlet portion 242, the high-purity alumina ball 243 is pushed backwards toward the inlet portion 242 and rests on the seat 242a to thereby close the inlet portion 242. As a result, fluid flow is blocked.

The high-purity alumina ball 243 of the present invention having an alumina purity of not less than 99.9% by mass exhibits excellent durability and can maintain long life even when applied to a check valve operating at high speed and high frequency, such as a check valve used in equipment for filling bottles and cans with drink.

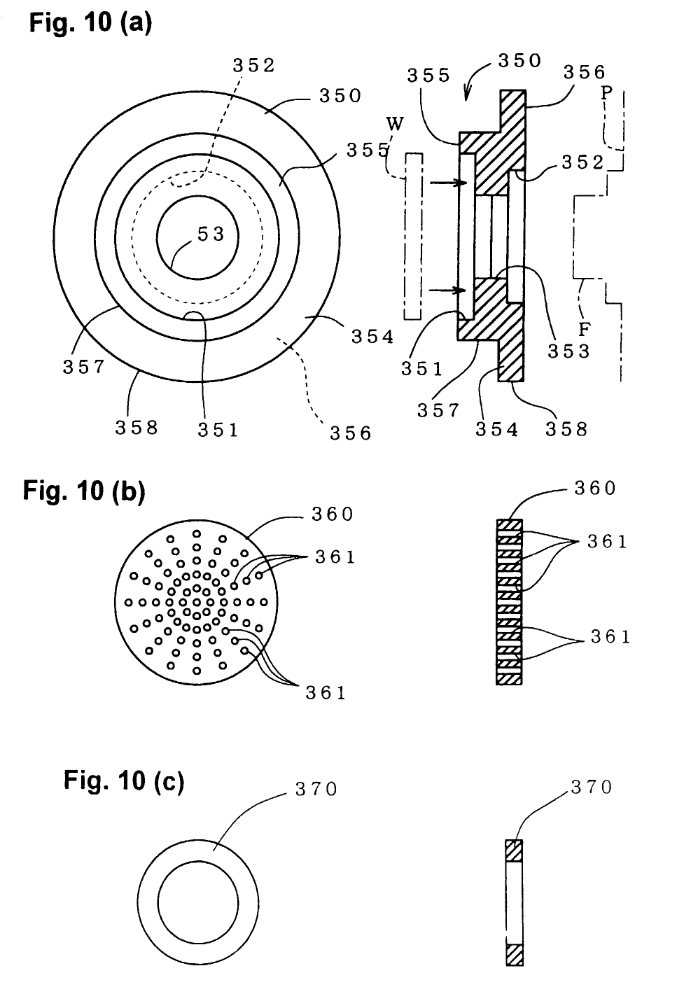

FIG. 10(a) shows an example of a jig for holding a wafer, which jig is formed from an alumina sintered body of the present invention. The alumina sintered body from which a jig 350 is formed has an alumina purity of not less than 99.9% by mass.

The jig 350 assumes a flat cylindrical shape and has a wafer-receiving recess 351 for receiving a wafer formed on one end surface 355. Also, the jig 350 has a positioning recess 352 formed on the other end surface 356 and a through-hole 353 formed therein connecting the recesses 351 and 352. The positioning recess 352 and the through-hole 353 are engaged with an engagement projection F formed on a mounting surface P within a semiconductor processing apparatus, to thereby position the jig 350 at a predetermined position on the mounting surface P. In order to stably fix the jig 350 on the mounting surface P, an outwardly-projecting flange portion 354 is formed at an end of the jig 350 at which the positioning recess 352 is formed.

The end surfaces 355 and 356 of the jig 350 are polished so as to be substantially parallel with each other. Furthermore, the entire surface of the jig 350 including outer circumferential surfaces 357 and 358 and wall surfaces of the wafer-receiving recess 351, the through-hole 353, and the positioning recess 352 are polished. Notably, a portion of the surface of the jig 350; for example, the outer circumferential surfaces 357 and 358, may be unpolished.

The above-mentioned jig 350 can be manufactured by, for example, the following method. A green body of the jig 350 is formed from the following power (A) or (B): (A) a high-purity alumina powder having an alumina purity of 99.99%, a 90% grain size of 1.96 μm, a 50% grain size of 0.68 μm, a 10% grain size of 0.32 μm, and a BET specific surface area of 11.0 and (B) a high-purity alumina powder having an alumina purity of 99.9%, a 90% grain size of 2.53 μm, a 50% grain size of 0.80 μm, a 10% grain size of 0.36 μm, and a BET specific surface area of 7.0 (the alumina powders (A) and (B) each contain, as impurities, an Si component of less than 10 ppm, an Na component of less than 5 ppm, an Mg component of less than 1 ppm, and an Fe component of less than 8 ppm). The thus-formed green body is sintered at a temperature of 1400-1700° C. for 2-10 hr, to thereby obtain a sintered body. The green body is formed by means of a pressing process and a subsequent cold isostatic pressing (CIP) process, so as to enhance the relative density thereof to 61%. Sintering may be performed by means of an ordinary sintering process using a sintering furnace, a hot pressing process, or a hot isostatic pressing (HIP) process.

The thus-obtained sintered body is subjected to grinding for dimensional adjustment and surface finishing to thereby obtain the final jig 350. Grinding can be performed by known methods. For example, the opposite end surfaces 355 and 356 can be ground by means of a surface grinder; the outer circumferential surfaces 357 and 358 can be ground by means of a cylindrical grinder; and the wall surfaces of the recesses 351 and 352 and the through-hole 353 can be ground by means of an internal cylindrical grinder.

FIG. 10(b) shows a holder plate for vacuum chucking serving as another example of a high-purity alumina sintered component of the present invention. A holder plate 360 has a number of evacuation holes 361 formed therein in the thickness direction. The holder plate 360 is mounted on an unillustrated evacuation box. By reducing the pressure within the evacuation box, an object is held on the holder plate 360 by means of evacuation through the evacuation holes 361. The holder plate 360 can be manufactured, for example, as follows. First, a green sheet is formed from the alumina powder (A) or (B). The thus-formed green sheet is cut into a predetermined shape to thereby obtain a green body. A number of through-holes, which become the evacuation holes 361, are formed in the green body, followed by firing. Grinding is performed on at least a surface of the sintered body which becomes a holding surface, to thereby yield the holder plate 360. When the evacuation holes 361 are sufficiently large in diameter, the respective wall surfaces of the evacuation holes 361 can be ground in the following manner: a slender grindstone is inserted into each of the evacuation holes 361 and is then rotated about the axis thereof. FIG. 10(c) shows an example of a ceramic seal ring 370 formed from an alumina sintered body of the present invention.

Since the above jigs are exposed to a corrosive atmosphere of high temperature in which corresponding objects are processed, the jigs must have sufficient strength and corrosion resistance against the atmosphere. The high-purity alumina sintered components of the embodiments described above can sufficiently meet these requirements.

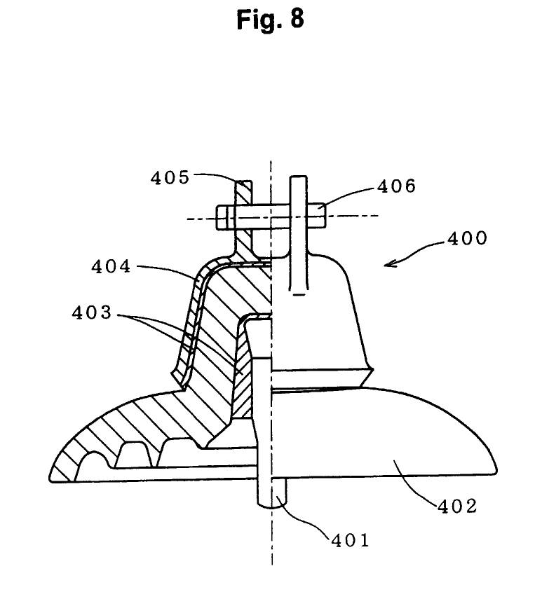

The high-purity alumina sintered body of the present invention is also applicable to an insulator. FIG. 8 shows an example of such an insulator. An insulator 400 is a so-called clevis-type suspension insulator. The insulator 400 is configured such that a hard porcelain 402 is held between and joined to a pin 401 and a cap 404, which are made of malleable cast iron or carbon steel, by means of cement layers 403. The hard porcelain 402 is formed from the high-purity alumina sintered body of the present invention. An upper portion of the cap 404 of the insulator 400 assumes the form of a lug 405. A pin of another insulator is inserted into the lug 405 and connected by means of a cotter bolt 406.

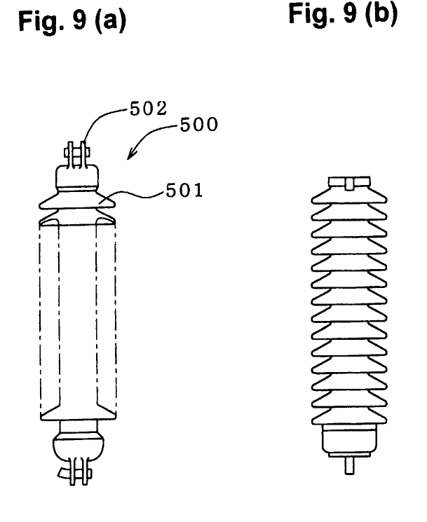

The high-purity alumina sintered body of the present invention is also applicable to a long rod insulator 500 shown in FIG. 9(a) and composed of a solid-core corrugated porcelain rod 501 and two connection metal members 502 located at opposite ends of the rod 501. The solid-core corrugated porcelain rod 501 is formed from the high-purity alumina sintered body of the present invention. Furthermore, the high-purity alumina sintered body of the present invention is applicable to a line post insulator as shown in FIG. 9(b) and a fog-type insulator.

The high-purity alumina balls obtained in the embodiments described above were analyzed for alumina purity by the ICP method and tested for corrosion resistance by the method described in JIS R1614 (1993), thereby studying the relationship between alumina purity and corrosion resistance. According to the JIS method, the alumina balls were immersed in aqueous solutions of sulfuric acid and sodium hydroxide in order to study the degree of corrosion thereof. The high-purity alumina balls and alumina sintered bodies of the Examples of the present embodiment (Samples (A) and (B)) exhibited good corrosion resistance; specifically, a weight loss of not greater than 100×10⁻⁴ kg/m² due to corrosion by H₂SO₄ or NaOH as measured according to JIS R1614 (1993). By contrast, alumina balls of the Comparative Examples (Samples (C), (D), and (E)) were inferior in corrosion resistance to those of the present invention.

The test results reveal that, at an alumina purity of not less than 99.9% by mass, the corrosion resistance of an alumina sintered body is greatly enhanced against acid and alkali. Particularly, by attaining a total content of an Si component, an Na component, an Mg component, and an Fe component, which are impurities, being less than 100 ppm, the corrosion resistance is enhanced. Also, when the content of the alkali metal component Na is less than 30 ppm, the corrosion resistance is particularly enhanced.

It should further be apparent to those skilled in the art that various changes in form and detail of the invention as shown and described above may be made. It is intended that such changes be included within the spirit and scope of the claims pended hereto.

This application is based on Japanese Patent Application No. 2000-188967 filed Jun. 23, 2000, the disclosure of which is incorporated herein by reference in its entirety.

What is claimed is:

1. A high-purity alumina sintered body having an alumina purity of not less than 99.9% by mass and a relative density of not less than 97% and exhibiting a weight loss of not greater than 100×10⁻⁴ kg/m² when immersed in boiling 6N H₂SO₄ or 6N NaOH aqueous solution for 24 hours.

2. The high-purity alumina sintered body as claimed in claim 1, containing Si, Mg, Fe and alkali metals as impurities in a total amount of less than 100 ppm.

3. A high-purity alumina sintered body having an alumina purity of not less than 99.9% by mass and a relative density of not less than 97% and containing, as impurities, Si, Mg, Fe and alkali metals in a total amount of less than 100 ppm.

4. The high-purity alumina sintered body as claimed in claim 2, containing alkali metals as impurities in a total amount of not greater than 30 ppm.

5. The high-purity alumina sintered body as claimed in claim 3, containing alkali metals as impurities in a total amount of not greater than 30 ppm.

6. A high-purity alumina ball formed of a high-purity alumina sintered body as claimed in claim 1.

7. A high-purity alumina ball formed of a high-purity alumina sintered body as claimed in claim 3.

8. A bearing comprising a high-purity alumina ball as claimed in claim 6.

9. A bearing comprising a high-purity alumina ball as claimed in claim 7.

10. A check value comprising a high-purity alumina ball as claimed in claim 6.

11. A check value comprising a high-purity alumina ball as claimed in claim 7.

12. A semiconductor jig formed of a high-purity alumina sintered body as claimed in claim 1.

13. A semiconductor jig formed of a high-purity alumina sintered body as claimed in claim 3.

14. An insulator formed of a high-purity alumina sintered body as claimed in claim 1.

15. An insulator formed of a high-purity alumina sintered body as claimed in claim 3.

16. A ball bearing comprising a plurality of high-purity alumina balls as claimed in claim 6 incorporated as rolling elements between an inner ring and an outer ring.

17. A ball bearing comprising a plurality of high-purity alumina balls as claimed in claim 7 incorporated as rolling elements between an inner ring and an outer ring.

18. A check valve comprising a valve body having a fluid path formed therein and a ball disposed within the fluid path so as to limit fluid flow within the fluid path to a single direction, wherein said ball is a high-purity alumina ball as claimed in claim 6.

19. A check valve comprising a valve body having a fluid path formed therein and a ball disposed within the fluid path so as to limit fluid flow within the fluid path to a single direction, wherein said ball is a high-purity alumina ball as claimed in claim 7.

20. A method for manufacturing a high-purity alumina sintered body, which comprises preparing a high-purity alumina sintered body having an alumina purity of not less than 99.9% by mass and a relative density of not less than 97% by forming a green body having a relative density of not less than 61% from a high-purity alumina powder having an alumina purity of not less than 99.9% by mass and subsequently firing the green body.

21. The method for manufacturing a high-purity alumina sintered body as claimed in claim 20, wherein the high-purity alumina powder contains, as impurities, Si, Mg, Fe and alkali metals in a total amount of less than 100 ppm.

22. The method for manufacturing a high-purity alumina sintered body as claimed in claim 20, comprising;
preparing a forming material powder from high-purity alumina powder having an alumina purity of not less than 99.9% by mass; placing the forming material powder in a granulation container; and rolling an aggregate of the alumina powder within the granulation container such that the aggregate grows into a spherical green body having a relative density of not less than 61%; and
firing the spherical green body.

23. The method for manufacturing a high-purity alumina sintered body as claimed in claim 21, comprising;
preparing a forming material powder from high-purity alumina powder having an alumina purity of not less than 99.9% by mass; placing the forming material powder in a granulation container; and rolling an aggregate of the alumina powder within the granulation container such that the aggregate grows into a spherical green body having a relative density of not less than 61%; and
firing the spherical green body.
